(19) United States
(12) Patent Application Publication
(10) Pub. No.: US 2022/0036081 A1
(43) Pub. Date: Feb. 3, 2022

(54) METHOD, IDENTIFICATION DEVICE AND NON-TRANSITORY COMPUTER READABLE MEDIUM FOR MULTI-LAYER POTENTIAL ASSOCIATES DISCOVERY

(71) Applicant: NEC Corporation, Minato-ku, Tokyo (JP)

(72) Inventors: Hui Lam ONG, Singapore (SG); Satoshi YAMAZAKI, Singapore (SG); Wei Jian PEH, Singapore (SG); Hong Yen ONG, Singapore (SG)

(73) Assignee: NEC Corporation, Minato-ku, Tokyo (JP)

(21) Appl. No.: 17/273,373

(22) PCT Filed: Aug. 20, 2019
(86) PCT No.: PCT/JP2019/032381

§ 371 Date: Mar. 4, 2021

(30) Foreign Application Priority Data
Sep. 6, 2018 (SG) 10201807663P

(51) Int. Cl. G06K 9/00

(52) U.S. Cl. CPC G06K 9/00711; G06K 9/00362; G06K 9/00771

(57) ABSTRACT

There is provided a method for identifying potential associates of at least one target person, the method comprising: providing a plurality of videos; identifying co-appearances with the at least one target person in the plurality of videos; determining potential associates based on the co-appearances with the at least one target person in the plurality of videos; identifying co-appearances with the potential associates in the plurality of videos; and determining further potential associates based on the further co-appearances with the potential associates in the plurality of videos.

### TECHNICAL FIELD

The present invention generally relates to systems and methods for multi-layer potential associates discovery, for example to methods for identifying potential associates of at least one target person, and identification devices.

### BACKGROUND ART

An organized crime group can be defined as a group of people working together on a continuing basis for coordination and planning of criminal activities. Their group structures vary, often consisting of a durable core of key individuals, cluster of subordinates, specialists, and other more transient members, plus an extended network of associates. Many such groups are often loose networks of criminals that come together for a specific criminal activity, acting in different roles depending on their skills and expertise.

To discover an organized crime group network of associates, apart from digital/cyberspace monitoring, the physical world's video surveillance systems can be the extended eye of law enforcement agencies to monitor and discover the potential network of associates.

### SUMMARY OF INVENTION

### Technical Problem

According to a first aspect, there is provided a method for identifying potential associates of at least one target person, the method comprising: providing a plurality of videos; identifying co-appearances with the at least one target person in the plurality of videos; determining potential associates based on the co-appearances with the at least one target person in the plurality of videos; identifying co-appearances with the potential associates in the plurality of videos; and determining further potential associates based on the further co-appearances with the potential associates in the plurality of videos.

According to a second aspect, there is provided an identification device configured to identify potential associates of at least one target person, the identification device comprising: a receiving module configured to receive a plurality of videos; a co-appearance identification module configured to identify co-appearances with the at least one target person in the plurality of videos; an associate determination module configured to determine potential associates based on the co-appearances with the at least one target person in the plurality of videos; wherein the co-appearance identification module is further configured to identify co-appearances with the potential associates in the plurality of videos; and wherein the associate determination module is further configured to determine further potential associates based on the further co-appearances with the potential associates in the plurality of videos.

According to a third aspect, there is provided a non-transitory computer readable medium having stored thereon instructions which, when executed by a processor, make the processor carry out a method for identifying potential associates of at least one target person, the method comprising: receiving a plurality of videos; identifying co-appearances with the at least one target person in the plurality of videos; determining potential associates based on the co-appearances with the at least one target person in the plurality of videos; identifying co-appearances with the potential associates in the plurality of videos; and determining further potential associates based on the further co-appearances with the potential associates in the plurality of videos.

### BRIEF DESCRIPTION OF DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1 shows a flow diagram illustrating a method for identifying potential associates of at least one target person according to various embodiments;

FIG. 2 shows an identification device for implementing the method illustrated in FIG. 1, according to various embodiments;

FIG. 3 shows a flow diagram illustrating a method for identifying potential associates according to various embodiments;

FIG. 4 shows an illustration of various layers in an exemplary processing of the method illustrated in FIG. 3.

FIG. 5 shows a flow diagram illustrating a method for identifying potential associates of at least one target person according to various embodiments;

FIG. 6 shows an identification device for implementing the method illustrated in FIG. 5, according to various embodiments;

FIG. 7 illustrates a video scene analysis for a single location and a single target person according to various embodiments;

FIG. 8 illustrates a video scene analysis for more than one location and more than one target person according to various embodiments;

FIG. 9 shows an illustration of how potential associates are identified according to various embodiments; and

FIG. 10 depicts an exemplary device according to various embodiments.

### DESCRIPTION OF EMBODIMENTS

Various embodiments provide devices and methods for identifying potential associates of at least one target person.

The physical world's video surveillance systems have long been the extended eye of law enforcement agencies to monitor criminal activities and discover the potential associates of organized crime groups, apart from digital/cyber surveillance.

Video surveillance systems are usually built and deployed to identify registered personnel, but some of the more advanced surveillance system also has the ability to track and associate people who are captured on camera together to build a registered person connection network. Video surveillance systems are usually built and deployed to identify specific targeted persons, but some of the more advanced surveillance systems also have the ability to track and associate people that are seen together with them to build a registered person connection network.

These existing solutions might be useful, but are limited to or are more suitable to discover the relation link among family members as well as friends and colleagues. Such solutions will also fail to discover hidden associates of a target person, especially in situations where the target person and his associates are not captured on camera together. For example, organized crime group's key individuals and their extended network of associates tend to stay off the grid and avoid being seen together to hide their connection during planning or execution of criminal activities. Most of them try to avoid communication through phone, emails, social networks (facebook, linkedin, etc) and instant messengers (whatsapp, line, wechat, etc) where there is a possibility to obtain the communication evidence through digital tracing by authorized law enforcers.

Further, some organized crime group members might make indirect contact or exchange information with their extended network of associates in crowded public areas that make it easier to cover their tracks and appearance. There is no surprise that some associates might not even know who they are communicating with. For instance, a first associate may be required to retrieve a physical object left in a public location by a second associate. By the time the first associate arrives at the designated public location to retrieve the object, the second associate may already have left. Even with a video surveillance system installed to monitor the location, both associates will not be caught on camera together since there is no direct communication between them.

It is a big challenge for law enforcement to discover organized crime group network of associates that not even aware by the associates themselves.

As a result of such careful ways of communication, there is difficulty for law enforcers to monitor and discover associates of such organized crime groups.

Hence, there exists a need to provide a solution to the above-mentioned problem.

The present invention provides a solution to the above-mentioned problem. During analysis of videos captured by surveillance cameras to identify possible associates of a target person, by extending the analysis range to include a period of time before a first appearance of the target person at a location captured by the surveillance cameras and another period of time after a last appearance of the target person at the same location, it is possible to discover unknown associates of the target person.

The results are further improved when videos of more than one target persons who belong to a same group are analysed. For example, if an unknown individual is found to appear in more than a threshold number of the videos, the probability that the unknown individual is an associate of the target persons is higher.

Advantageously, the present invention allows identification of potential associates of a target person, even if they are not co-appearing together in the videos.

Advantageously, the probability that the identified potential associates are indeed associates of the target person is increased when videos of more than one target persons are analysed.

Advantageously, the organized crime group networks of associates that not even aware by the associates themselves may be discovered.

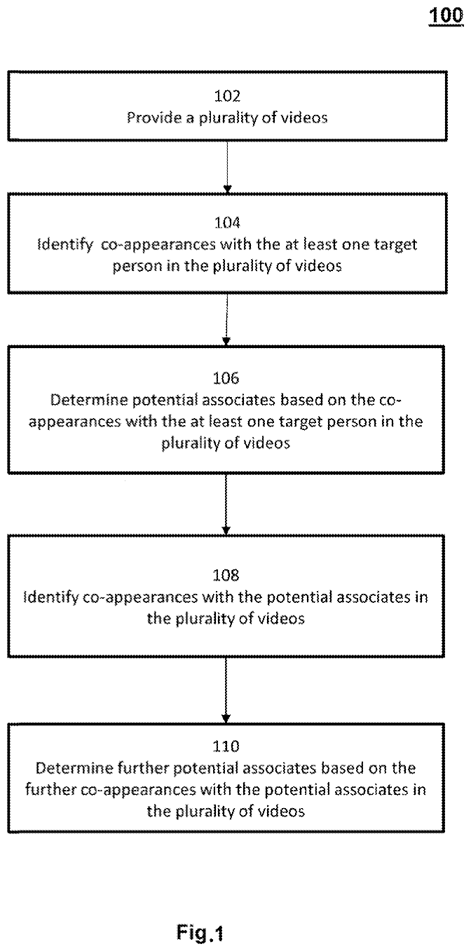

FIG. 1 shows a flow diagram 100 illustrating a method for identifying potential associates of at least one target person according to various embodiments. In 102, a plurality of videos may be provided. The plurality of videos may be video recordings of locations captured by surveillance cameras, hand phone cameras, CCTV (closed-circuit television) cameras, web-cams or other similar devices. The locations may be places where the at least one target person has been seen, known to have been to or frequented, or suspected locations where the at least one target person provides or receives information to or from associates of the same criminal group. The plurality of videos may be in a file format such as mp4, avi, mkv, wmv, mov or other similar video format. Further, each of the plurality of videos may indicate a time, date and location at which each respective video is recorded. In an embodiment, the plurality of videos may be processed into an entry database consisting of one or more entries, wherein each of the one or more entries represents an appearance of a person at a time, date and location in the plurality of videos, wherein each of the one or more entries indicates an attribute of the person.

In 104, co-appearances with the at least one target person in the plurality of videos (in other words: occurrences where an individual co-appears with the at least one target person in the plurality of videos in one of the videos) are identified. In 106, potential associates are determined based on the co-appearances with the at least one target person in the plurality of videos.

In 108, co-appearances with the potential associates may be identified in the plurality of videos. For example, processing may be similar or identical to processing in step 104 described above, but with the potential associates as identification target (instead of the at least one target person). In 110, further potential associates may be determined based on the further co-appearances with the potential associates in the plurality of videos. In a next step, which is not illustrated in FIG. 1, processing similar or identical to the steps 104, 106, 108, 110 may be performed with the further potential associates as identification target (instead of at least one target person, or instead of the potential associates).

Furthermore, it may be determined whether the co-appearances with the potential associates in the plurality of videos include co-appearances that are not included in the co-appearances with the at least one target person in the plurality of videos.

The further potential associates may be determined solely based on the further co-appearances with the potential associates in the plurality of videos, if it is determined that the co-appearances with the potential associates in the plurality of videos include co-appearances that are not included in the co-appearances with the at least one target person in the plurality of videos.

The further potential associates may be determined based on the co-appearances with the at least one target person in the plurality of videos and based on the further co-appearances with the potential associates in the plurality of videos, if it is determined that the co-appearances with the potential associates in the plurality of videos do not include co-appearances that are not included in the co-appearances with the at least one target person in the plurality of videos.

Furthermore, it may be determined whether the further potential associates include individuals that are not included in the potential associates.

Processing may re-iterate, if it is determined that the further potential associates include individuals that are not included in the potential associates.

Processing may end, if it is determined that the further potential associates do not include individuals that are not included in the potential associates.

The method described with reference to FIG. 1 may provide a multi-layer group associates adaptive network discovery using video surveillance data, which may allow associate network discovery using newly discovered associates of the associates to extend search scope to global co-appearance result subsets.

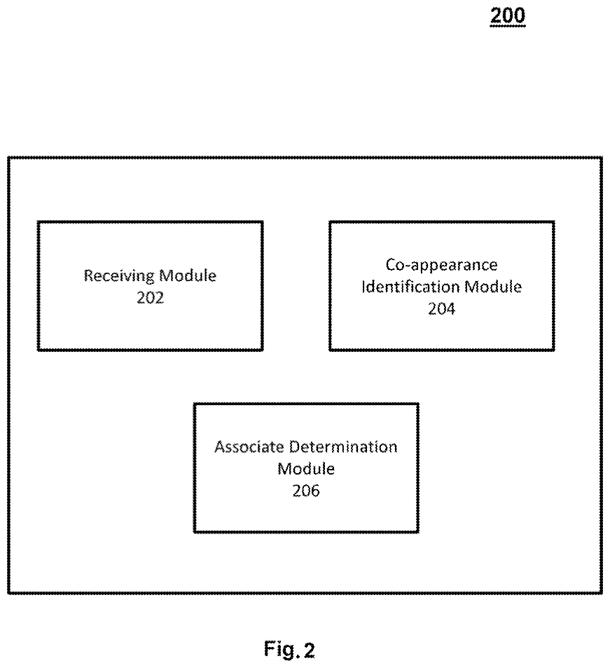

FIG. 2 shows an identification device 200 for implementing the method illustrated in FIG. 1, according to various embodiments. The identification device 200 may include a receiving module 202 configured to receive a plurality of videos. The identification device 200 may further include a co-appearance identification module 204 configured to identify co-appearances with the at least one target person in the plurality of videos. The identification device 200 may further include an associate determination module 206 configured to determine potential associates based on the co-appearances with the at least one target person in the plurality of videos. The co-appearance identification module 204 may further be configured to identify co-appearances with the potential associates in the plurality of videos. The associate determination module 206 may further be configured to determine further potential associates based on the further co-appearances with the potential associates in the plurality of videos.

The co-appearance identification module 204 may further be configured to determine whether the co-appearances with the potential associates in the plurality of videos include co-appearances that are not included in the co-appearances with the at least one target person in the plurality of videos.

The associate determination module 206 may further be configured to determine the further potential associates solely based on the further co-appearances with the potential associates in the plurality of videos, if it is determined that the co-appearances with the potential associates in the plurality of videos include co-appearances that are not included in the co-appearances with the at least one target person in the plurality of videos.

The associate determination module 206 may further be configured to determine the further potential associates based on the co-appearances with the at least one target person in the plurality of videos and based on the further co-appearances with the potential associates in the plurality of videos, if it is determined that the co-appearances with the potential associates in the plurality of videos do not include co-appearances that are not included in the co-appearances with the at least one target person in the plurality of videos.

The associate determination module 206 may further be configured determine whether the further potential associates include individuals that are not included in the potential associates.

The identification device 200 may be configured to re-iterate processing, if it is determined that the further potential associates include individuals that are not included in the potential associates.

The identification device 200 may be configured to end processing, if it is determined that the further potential associates do not include individuals that are not included in the potential associates.

According to various embodiments, there is provided a non-transitory computer readable medium having stored thereon instructions which, when executed by a processor, make the processor carry out a method for identifying potential associates of at least one target person, for example the method described with reference to FIG. 1 above.

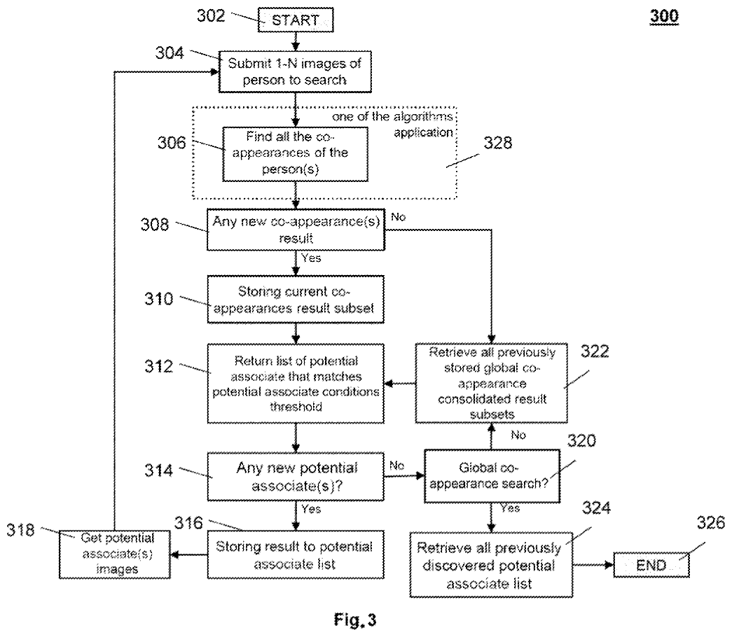

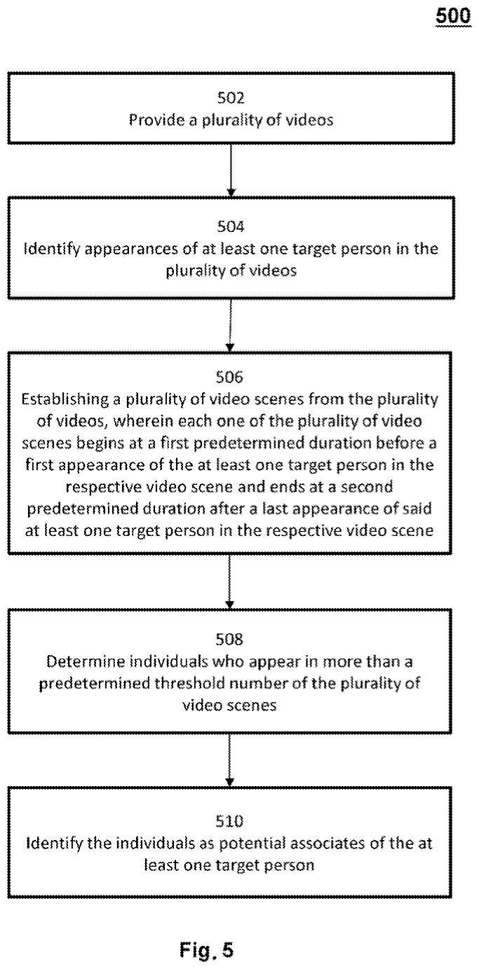

FIG. 3 shows a flow diagram 300 illustrating a method for identifying potential associates according to various embodiments. Processing may start at step 302. At step 304, an integer number (for example between 1 and N) images of person(s) to search may be submitted. At step 306, all the co-appearances of the person(s) may be found. For this step, a method (or algorithm) like will be described in more detail below with reference to FIG. 5 to FIG. 9 may be used, like indicated by box 328. At step 308, it may be determined whether any new co-appearance(s) results have been found. If no new co-appearance(s) results have been found, processing may proceed at step 322. If new co-appearance(s) results have been found, processing may proceed at step 310. At step 310, current co-appearances may be stored (for example in a result subsheet). At step 312, a list of potential associates that matches a pre-determined potential associate conditions threshold may be returned. At step 314, it may be determined whether any new potential associate(s) have been found. If new potential associate(s) have not been found, processing may proceed at step 320. If new potential associate(s) have been found, processing may proceed at step 316. At step 316, the results may be stored to the potential associate list, and processing may proceed at step 318, where potential associate(s) images may be obtained. At step 320, it may be determined whether the results have been found based on a global co-appearance search (in other words: global co-appearance analysis). If the results have not been found based on a global co-appearance, processing may proceed at step 322, where all previously stored global co-appearance consolidated result subsets may be retrieved. If the results have been found based on a global co-appearance, processing may proceed at step 324, where a list of all previously discovered potential associates may be retrieved. Processing may then end at step 326. In other words, processing may continue as long as (new) results (for potential associates) are found either based on a local co-appearance search or based on a global co-appearance search. If (new) results are not found based on a local co-appearance search, a global co-appearance search may be initiated. If (new) results are found in the global co-appearance search, processing may proceed with a local co-appearance search. If no (new) results are found in the global co-appearance search, processing may end. It will be understood that a local co-appearance search is a search based on potential associates identified in the previous iteration of the search (or based on the at least one target person for the first iteration). It will be understood that a global co-appearance search is a search based on all potential associates identified in all of the previous iterations of the search and the at least one target person.

In the processing of FIG. 3, each loop may be referred to as one layer, so that a multi-layers group associates network discovery method may be provided.

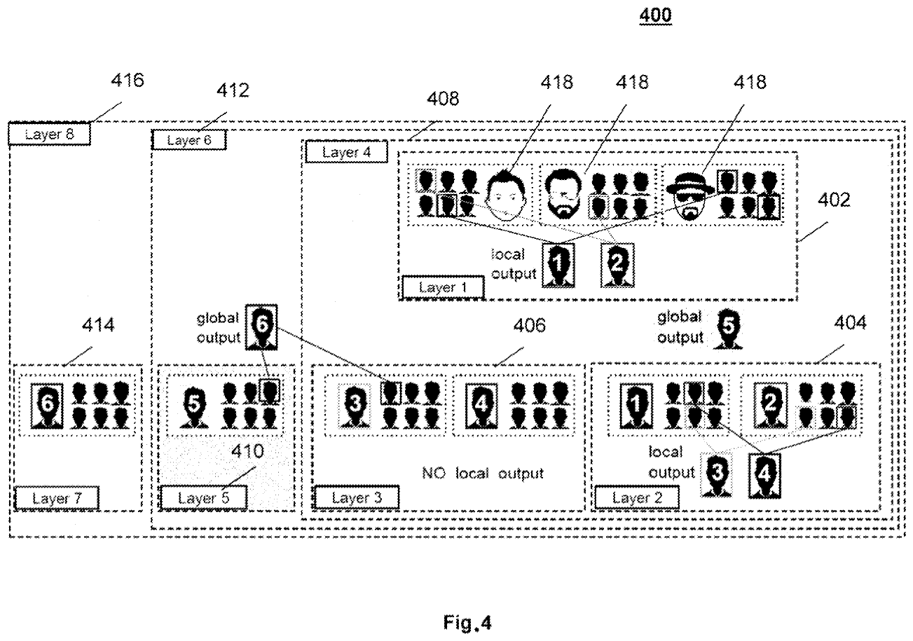

FIG. 4 shows an illustration 400 of various layers in an exemplary processing of the method illustrated in FIG. 3. In a first layer 402, three target persons 418 may be provided, and person 1 and person 2 may be identified as potential associates of the three target persons 418. In a second layer 404, person 3 and person 4 may be identified as potential associates of person 1 and person 2. In a third layer 406, potential associates of person 3 and person 4 may be identified, but there may be no such potential associates. As such, in a fourth layer 408, a global analysis may be carried out; in other words, potential associates may be discovered based on the (initial) target persons 418 and all previously discovered potential associates (i.e. person 1, person 2, person 3, and person 4). In the fourth layer, person 5 may be identified as potential associated. In a fifth layer 410, there may not be found any potential associate for person 5, so that in a sixth layer 412 again a global analysis may be carried out based on the (initial) target persons 418 and all previously discovered potential associates (i.e. person 1, person 2, person 3, person 4, and person 5), so that person 6 may be identified as a potential associate. In layer 414, it may be found that there is no potential associate for person 6. In the subsequent global analysis in an eighth layer 416, again no further potential associate may be discovered, so that processing may end and may output the list of person 1, person 2, person 3, person 4, person 5, and person 6 as the resulting list of potential associates.

According to various embodiments, identification of the (further) potential associates may be carried out as described in the following.

FIG. 5 shows a flow chart illustrating a method for identifying potential associates of at least one target person. In 502, a plurality of videos is provided. The plurality of videos may be video recordings of locations captured by surveillance cameras, hand phone cameras, CCTV (closed-circuit television) cameras, web-cams or other similar devices. The locations may be places where the at least one target person has been seen, known to have been to or frequented, or suspected locations where the at least one target person provides or receives information to or from associates of the same criminal group. The plurality of videos may be in a file format such as mp4, avi, mkv, wmv, mov or other similar video format. Further, each of the plurality of videos may indicate a time, date and location at which each respective video is recorded. In an embodiment, the plurality of videos may be processed into an entry database consisting of one or more entries, wherein each of the one or more entries represents an appearance of a person at a time, date and location in the plurality of videos, wherein each of the one or more entries indicates an attribute of the person.

In 504, appearances of the at least one target person in the plurality of videos are identified. This identification process may be achieved by determining an attribute of the respective target person, and then identifying, from the plurality of videos, an individual possessing the attribute as the respective target person. For example, the attribute may be facial information of the at least one target person which may be determined from a picture of the at least one target person's face. The attribute may also be a physical characteristic of the at least one target person, for example height, body size, hair colour, skin colour, other physical features or combinations thereof of such features that may be used to identify the at least one target person from the plurality of videos. The attribute may also be a behavioural characteristic of the at least one target person such as, for example, the way the at least one target person walks, stands, moves, talks, other similar characteristics or combinations thereof that may be used to identify the target person from the plurality of videos.

In 506, a plurality of video scenes is established from the plurality of videos, wherein each one of the plurality of video scenes begins at a first predetermined duration before a first appearance of the at least one target person in the respective video scene and ends at a second predetermined duration after a last appearance of said at least one target person in the respective video scene. Each of the plurality of video scenes may comprise surveillance footage of a location where at least one appearance of the targeted person is identified. Practically, most locations would typically have more than one surveillance camera installed to monitor the respective locations, such that each of these surveillance cameras may either provide surveillance for different parts of the location, or monitor the location from different views or angles. Therefore, each of the plurality of video scenes may further comprise one or more camera surveillance footages of a respective location where at least one appearance of the respective target person is identified. Advantageously, taking into consideration all available surveillance footages of a location can cover scenarios in which the target person is at a spot where only one of the surveillance cameras can capture the person on video.

Further, each of the plurality of video scenes is established such that each video scene begins at a first predetermined duration before a first identified appearance of the at least one target person, and ends at a second predetermined duration after a last appearance of the at least one target person. For example, where a first and a last appearance of a target person at a location is at 2 pm and 3 pm on a same date respectively with intermediate appearances at 2.10 pm, 2.25 pm, 2.40 pm and 2.50 pm, and the first and second predetermined duration are set as 20 minutes and 25 minutes respectively, then the resulting video scene will begin at 1.40 pm and end at 3.25 pm on the same date.

In 508, individuals who appear in more than a predetermined threshold number of the plurality of video scenes are determined. The individuals refer to all other persons besides the at least one target person who appear in the plurality of video scenes. These individuals do not need to be seen communicating with the at least one target person in the plurality of video scenes in order to be considered as potential associates, as long as they are found to appear in more than a predetermined threshold number of video scenes. The predetermined threshold number may be determined by trial and error, and may vary depending on the quantity or quality of videos to be analysed. Appearances of each individual may be identified based on a determined attribute of the respective individual, such as facial information, physical characteristics, behaviour characteristics or other attributes that may be used to identify the individual.

In 510, the individuals who appear in more than the predetermined threshold number of the video scenes are identified as potential associates of the at least one target person.

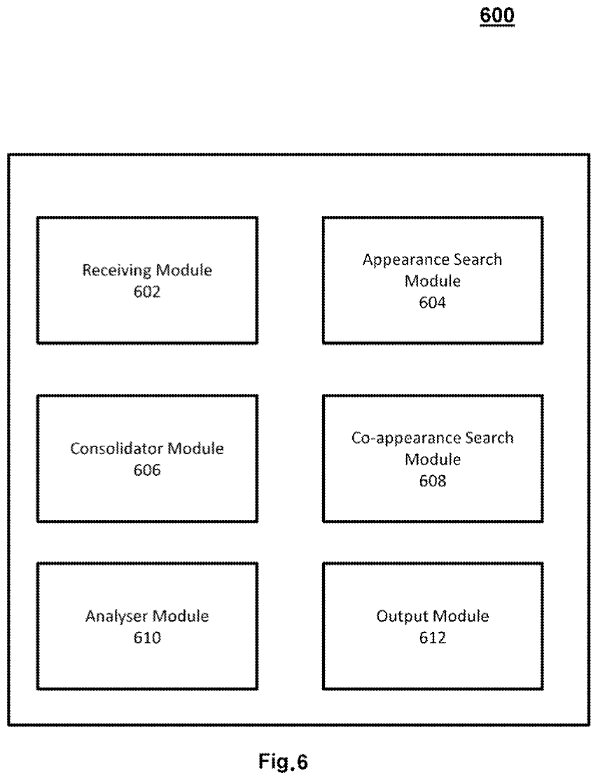

FIG. 6 shows an identification device 600 configured to implement the method illustrated in FIG. 5. The device 600 includes a receiving module 602, an appearance search module 604, a consolidator module 606, a co-appearance search module 608, an analyser module 610 and an output module 612.

The receiving module 602 is configured to receive a plurality of videos. The plurality of videos may be video recordings of locations captured by surveillance cameras, hand phone cameras, CCTV (closed-circuit television) cameras, web-cams or other similar devices. The locations may be places where the at least one target person has been seen, known to have been to or frequented, or suspected locations where the at least one target person provides or receives information to or from associates of the same criminal group. The plurality of videos may be in a file format such as mp4, avi, mkv, wmv, mov or other similar video format. Further, each of the plurality of videos may indicate a time, date and location at which each respective video is recorded.

The appearance search module 604 is configured to identify appearances of the at least one target person in the plurality of videos. In an embodiment, the appearance search module 604 may be further configured to determine an attribute of a respective target person of the at least one target person and identify, from the plurality of videos, an individual possessing the attribute as the respective target person. For example, the attribute may comprise facial information, a physical characteristic or a behavioural characteristic of the respective target person.

The appearance consolidator module 606 is configured to establish a plurality of video scenes from the plurality of videos, wherein each one of the plurality of video scenes begins at a first predetermined duration before a first appearance of the at least one target person in the respective video scene and ends at a second predetermined duration after a last appearance of said at least one target person in the respective video scene. In an embodiment, the plurality of video scenes may further comprise one or more camera surveillance footage of a location. Further, each of the one or more camera surveillance footages may show a different view of the location.

The co-appearance search module 608 is configured to search for individuals who appear in the plurality of video scenes. In an embodiment, appearances of each individual may be identified based on a determined attribute of the respective individual, such as facial information, physical characteristics, behaviour characteristics or other attributes that may be used to identify the individual.

The appearance analyzer module 610 is configured to determine which of the individuals appear in more than a predetermined threshold number of the plurality of video scenes. The output module 612 is configured to identify the individuals who appear in more than a predetermined threshold number of the plurality of video scenes as the potential associates of the at least one target person.

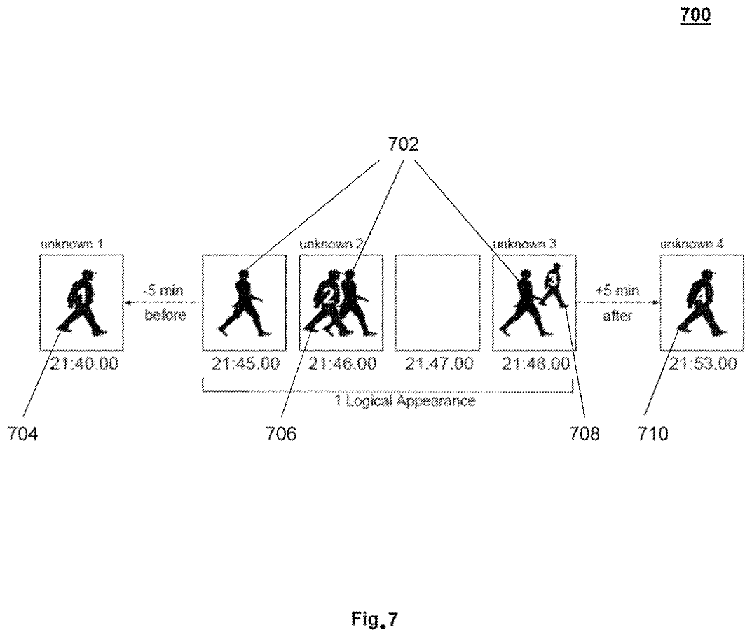

FIG. 7 illustrates a video scene analysis for a single location and a single target person according to various embodiments. A video scene 700 comprises video footage from one or more surveillance cameras of a single location at a particular date. In this embodiment, a first appearance of a target person 702 occurs at 2145 hours and a last appearance of the target person occurs at 2148 hours. Further, a first predetermined duration and a second predetermined duration are both set as 5 minutes. Accordingly, the video scene 700 begins at the first predetermined duration before the first appearance of the target person, which is at 2140 hours, and ends at the second predetermined duration after the last appearance of the target person, which is 2153 hours. Further, the video scene 700 may not require a continuous presence of the target person 702. For example, the target person 702 is not present for 2 minutes between 2146 hours and 2148 hours in the video scene 700. Since the 2 minute absence of the target person 702 is shorter than the second predetermined duration of 5 minutes, the appearance of the target person 702 at 2146 hours is not considered as the last appearance. Therefore, the period of time from 2145 hours to 2148 hours of video scene 700 comprises one logical appearance of the target person 702.

In an embodiment, there may be a third predetermined duration for limiting a duration of each time that a target person can be absent in a video scene. Referring to video scene 700, a third predetermined duration may be set as, for example, 20 minutes. This means that a maximum duration for each time that the target person 702 can be absent in the video scene 700 is 20 minutes. In the video scene 700, the target person 702 is not present for 2 minutes between 2146 hours and 2148 hours. Since the 2 minute absence of the target person 702 is shorter than the third predetermined duration of 20 minutes, the appearance of the target person 702 at 2146 hours is not considered as a last appearance. Therefore, the period of time from 2145 hours to 2148 hours of video scene 700 comprises one logical appearance of the target person 702. If, for example, the period of absence starting from 2147 hours of the target person 702 exceeds the third predetermined duration, the video scene 700 will instead end at the second predetermined duration of 5 minutes after 2147 hours, at 2152 hours. Further, if the target person 702 then reappears in the plurality of videos after 2152 hours, for example at 2230 hours, a new video scene will be established starting at the first predetermined duration of 5 minutes before 2230 hours, at 2225 hours. In this case, the period of time from 2145 hours to 2147 hours comprises one logical appearance of the target person 702, and the period of time that starts at 2230 hours until a next last appearance of the target person 702 comprises another logical appearance of the target person 702. It will be appreciated that the first, second and third predetermined duration may be set to any duration that may be deemed suitable for analysis of the video scenes.

Next, individuals other than the target person 702 are identified. In the video scene 700, a first unknown individual 704 appears walking alone at 2140 hours, a second unknown individual 706 appears walking beside the target person 702 at 2146 hours, a third unknown individual 708 appears walking at a distance from target person 702, and a fourth unknown individual 710 is seen walking alone at 2153 hours. Accordingly, an attribute of each of these four unknown individuals are determined for comparison with other video scenes. For example, the attribute may be facial information which may be determined from captured videos of the each of the four unknown individuals' faces. The attribute may also be a physical characteristic of each of the four unknown individuals, for example height, body size, hair colour, skin colour, and other physical features or combinations thereof. The attribute may also be a behavioural characteristic of each of the four unknown individuals such as, for example, the way each of the four unknown individuals walk, stand, move, talk, other similar characteristics or combinations thereof.

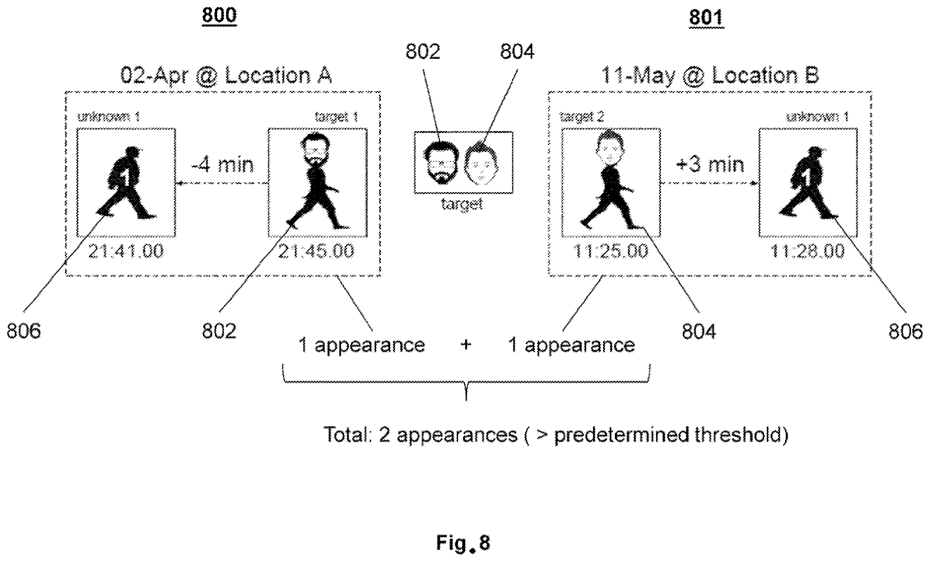

FIG. 8 illustrates a video scene analysis for more than one location and more than one target person according to various embodiments. Two video scenes 800 and 801 are being analysed. Video scene 800 comprises video surveillance footage for a Location A on 2nd April, at which a first target person 802 appears at 2145 hours. Video scene 801 comprises video surveillance footage for a Location B on 11th May, at which a second target person 804 appears at 1125 hours. In video scene 800, an unknown individual 806 appears at 2141 hours, 4 minutes before the appearance of the target person 802. In video scene 801, the same unknown individual 806 appears at 1128 hours, 3 minutes after the appearance of target person 804. Accordingly, the unknown individual 806 is now determined to appear in 2 video scenes. In an embodiment where the predetermined threshold number is set as 1, the unknown individual 806 will be identified as a potential associate of target persons 802 and 804.

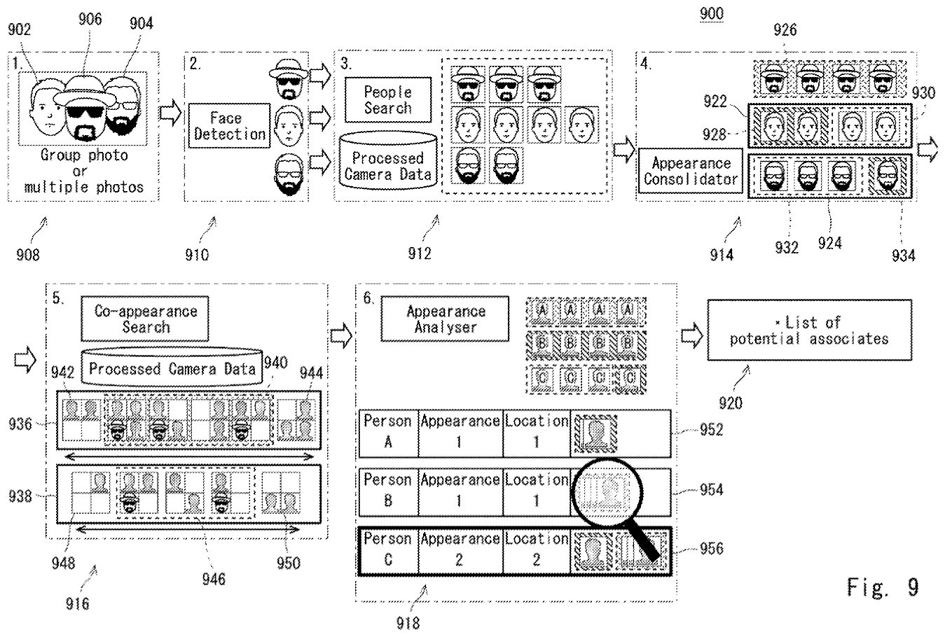

FIG. 9 shows an illustration 900 of how potential associates are identified. Firstly, an attribute of at least one target person is determined. For example, the attribute may be facial information of the at least one target person which may be determined from a picture of the at least one target person's face. The attribute may also be a physical characteristic of the at least one target person, for example height, body size, hair colour, skin colour, and other physical features or combinations thereof. The attribute may also be a behavioural characteristic of the at least one target person such as, for example, the way the at least one target person walks, stands, moves, talks, other similar characteristics or combinations thereof. In the present embodiment, at 908, a group photo or multiple photos of three target persons 902, 904 and 906 are provided. At 910, facial information of target persons 902, 904 and 906 are detected from the provided photos. The detected facial information may then be used as the attribute. It will be appreciated that the photographs may be physical copies or soft copies, where the physical copies may be scanned to detect the facial features of the target persons. Further, other mediums such as videos can also be used for determining the attributes.

Further, a plurality of videos is provided. The plurality of videos may be video recordings of locations captured by surveillance cameras, hand phone cameras, CCTV (closed-circuit television) cameras, web-cams or other similar devices. The locations may be places where the at least one target person has been seen, known to have been to or frequented, or suspected locations where the at least one target person provides or receives information to or from associates of the same criminal group. The plurality of videos may be in a file format such as mp4, avi, mkv, wmv, mov or other similar video format. Further, each of the plurality of videos may indicate a time, date and location at which each respective video is recorded. In an embodiment, the plurality of videos may be processed into an entry database consisting of one or more entries, wherein each of the one or more entries represents an appearance of a person at a time, date and location in the plurality of videos, wherein each of the one or more entries indicates an attribute of the person.

At 912, appearances of the three target persons 902, 904 and 906 are identified from the plurality of videos. This may be achieved by identifying, from the plurality of videos, an individual possessing the determined attribute as the respective target person. In the present embodiment, the attribute used for the identification of target persons 902, 904 and 906 in the plurality of videos is the facial information as determined in 910. For example, an individual appearing in the plurality of videos and having the same facial information as target person 902 will be identified as the target person 902, an individual appearing in the plurality of videos and having the same facial information as target person 904 will be identified as the target person 904, and an individual appearing in the plurality of videos and having the same facial information as target person 906 will be identified as the target person 906.

After identifying all video appearances of the target persons 902, 904 and 906 in the plurality of videos, at 914, an appearance consolidator consolidates the identified video appearances of the three target persons 902, 904 and 906 from the plurality of videos. For example, identified video appearances 922 is based on the identified appearances in the plurality of videos of target person 902, identified video appearances 924 is based on the identified appearances in the plurality of videos of target person 904 and identified video appearances 926 is based on the identified appearances in the plurality of videos of target person 906. The consolidation may be based on a time range, a date, a location or a combination thereof, wherein identified appearances of a target person that occur at a same location, date and/or time range may be grouped together to form a logical appearance sequence.

The identified video appearances of the target persons may come from one or more videos of the plurality of videos. In the present embodiment, identified video appearances 926 is based on appearances of target person 906 in one or more videos of the plurality of videos, wherein the one or more videos may occur at a same time range, date, location or a combination thereof, such that the video appearances 926 comprises one logical appearance of the target person 906. Identified video appearances 922 is based on appearances of target person 902 in at least two videos of the plurality of videos, where video appearances 928 of target person 902 are identified from a first batch of one or more videos, and video appearances 930 of target person 902 are identified from a second batch of one or more videos. The first batch of one or more videos may occur at a same time range, date, location or a combination thereof, such that the video appearances 928 comprises one logical appearance of the target person 902. Likewise, the second batch of one or more videos may occur at a same time range, date, location or a combination thereof, such that the video appearances 930 comprises one logical appearance of the target person 902. For example, the first and second batch of one or more videos may be surveillance videos of a location recorded on a same date, where video appearances 928 of target person 902 from the first batch of one or more videos may be occurring at an earlier time and video appearances 930 of target person 902 from the second batch of one or more videos may be occurring at a later time, such that video appearances 928 forms a first logical appearance of target person 902, while video appearances 930 forms a second logical appearance of target person 902. Accordingly, the consolidated video appearances 922 comprises two logical appearances of target person 902.

Further, identified appearances 924 is based on appearances of target person 904 in at least two videos of the plurality of videos, where video appearances 932 of target person 904 are identified from a first batch of one or more videos, and video appearances 934 of target person 904 are identified from a second batch of one or more videos. The first batch of one or more videos may occur at a same time range, date, location or a combination thereof, such that the video appearances 932 comprises one logical appearance of the target person 904. Likewise, the second batch of one or more videos may occur at a same time range, date, location or a combination thereof, such that the video appearances 934 comprises one logical appearance of the target person 904. For example, the first and second batch of one or more videos may be surveillance videos of a location recorded on a same date, where video appearances 932 of target person 904 from the first batch of one or more videos may be occurring at an earlier time and video appearances 934 of target person 904 from the second batch of one or more videos may be occurring at a later time, such that video appearances 932 forms a first logical appearance of target person 904, while video appearances 934 from a second logical appearance of target person 904. Accordingly, the consolidated video appearances 924 comprises two logical appearances of target person 904. It will be appreciated that more than one consolidated video appearances for each target person may be formed based on the identified appearances, where each consolidated appearance may correspond to a time range, a date, a location, or combinations thereof in which the identified appearances occur in the plurality of videos.

Based on the identified logical appearances that are consolidated at 914, a plurality of video scenes is established by the appearance consolidator. At 916, video scene 936 is established based on, for example, the consolidated appearances 926 of target person 906. The video scene 936 comprises a first portion 940, a second portion 942 and a third portion 944. The first portion 940 may comprise a one or more video footages from which consolidated video appearances 926 of target person 906 are identified. The first portion 940 may further comprise one or more video footages in which appearances of the target person 906 are not found, but these one or more video footages are of a time, a date, a location, or combinations thereof that matches the time, the date, the location, or combinations thereof of the one or more video footages from which the consolidated video appearances 926 of target person 906 are identified. Advantageously, this will take into consideration all available surveillance footage of a location, so as to cover scenarios in which the target person is at a spot where only one of the surveillance cameras can capture the person on video.

In addition to the first portion 940 of the video scene 936, the second portion 942 extends the duration of the video scene 936 by a first predetermined duration, such that the video scene 936 begins at the first predetermined duration before a first appearance of the target person 906 as identified in the first portion 940 of the video scene 936. Accordingly, the second portion 942 may comprise one or more video footages of a time, a date, a location, or combinations thereof that matches the time, the date, the location, or combinations thereof of the one or more video footages of the first portion 940 of video scene 936, wherein the one or more video footages of the second portion 942 begins at the first predetermined duration before the first appearance of the target person 906 as identified in the first portion 940 of the video scene 936. Advantageously, the inclusion of the second portion 942 of the video scene 936 allows identification of potential associates of the target person 906 even if they are not co-appearing together with the target person 906 in the videos, but only appearing before the target person 906 arrives at the recorded location, possibly just to leave an object for retrieval by the target person 906.

Further, there is the third portion 944 of the video scene 936 that extends the duration of the video scene 936 by a second predetermined duration, such that the video scene 936 ends at the second predetermined duration after a last appearance of the target person 906 as identified in the first portion 940 of the video scene 936. Accordingly, the third portion 944 may comprise one or more video footages of a time, a date, a location, or combinations thereof that matches the time, the date, the location, or combinations thereof of the one or more video footages of the first portion 940 of video scene 936, wherein the one or more video footages of the third portion 944 ends at the second predetermined duration after the last appearance of the target person 906 as identified in the first portion 940 of the video scene 936. Advantageously, the inclusion of the third portion 944 of the video scene 936 allows identification of potential associates of the target person 906 even if they are not co-appearing together with the target person 906 in the videos, but only appearing after the target person 906 leaves the recorded location, possibly to retrieve an object that was intentionally left behind by the target person 906.

Similar to video scene 936, video scene 938 is established based on, for example, video appearances 932 in the consolidated appearances 924 of target person 904. The video scene 938 comprises a first portion 946, a second portion 948 and a third portion 950. The first portion 946 may comprise one or more video footages from which video appearances 932 of target person 904 are identified. The first portion 946 may further comprise one or more video footages in which appearances of the target person 904 are not found, but these one or more video footages are of a time, a date, a location, or combinations thereof that matches the time, the date, the location, or combinations thereof of the one or more video footages from which the consolidated video appearances 932 of target person 904 are identified. Advantageously, this will take into consideration all available surveillance footage of a location, so as to cover scenarios in which the target person is at a spot where only one of the surveillance cameras can capture the person on video.

In addition to the first portion 946 of the video scene 938, the second portion 948 extends the duration of the video scene 938 by a first predetermined duration, such that the video scene 938 begins at the first predetermined duration before a first appearance of the target person 904 as identified in the first portion 946 of the video scene 938. Accordingly, the second portion 948 may comprise one or more video footages of a time, a date, a location, or combinations thereof that matches the time, the date, the location, or combinations thereof of the one or more video footages of the first portion 946 of video scene 938, wherein the one or more video footages of the second portion 948 begins at the first predetermined duration before the first appearance of the target person 904 as identified in the first portion 946 of the video scene 938. Advantageously, the inclusion of the second portion 948 of the video scene 938 allows identification of potential associates of the target person 904 even if they are not co-appearing together with the target person 904 in the videos, but only appearing before the target person 904 arrives at the recorded location, possibly just to leave an object for retrieval by the target person 904.

Further, there is the third portion 950 of the video scene 938 that extends the duration of the video scene 938 by a second predetermined duration, such that the video scene 938 ends at the second predetermined duration after a last appearance of the target person 904 as identified in the first portion 946 of the video scene 938. Accordingly, the third portion 950 may comprise one or more video footages of a time, a date, a location, or combinations thereof that matches the time, the date, the location, or combinations thereof of the one or more video footages of the first portion 946 of video scene 938, wherein the one or more video footages of the third portion 950 ends at the second predetermined duration after the last appearance of the target person 904 as identified in the first portion 946 of the video scene 938. Advantageously, the inclusion of the third portion 950 of the video scene 938 allows identification of potential associates of the target person 904 even if they are not co-appearing together with the target person 904 in the videos, but only appearing after the target person 904 leaves the recorded location, possibly to retrieve an object that was intentionally left behind by the target person 904.

After establishment of the video scenes 936 and 938, a co-appearance search module determines every individual besides the target persons 902, 904 and 906 who appear in the video scenes. The determination process may comprise determining an attribute of each of the one or more individuals who appear in any of the video scenes 936 and 938. The attribute may be, for example, facial information, physical characteristics, behaviour characteristics, other similar characteristics or combinations thereof that may be used to identify each of the one or more individuals. The determination process may further comprise determining a time, a date, a location, a target person who appeared in the same video scene as the respective individual, or combinations thereof for each of the one or more individuals who appear in any of the video scenes 936 and 938. The determination process includes all three portions 940, 942 and 944 of video scene 936, as well as all three portions 946, 948 and 950 of video scene 938. Advantageously, individuals who appear within the first predetermined duration before the first appearance of the respective target person in the respective video scene, and individuals who appear within the second predetermined duration after the last appearance of the respective target person in the respective video scene are considered in the determination process. It will be understood that video scenes will similarly be established for each of the remaining video appearances 928, 930 and 934, where these video scenes will also be considered in the determination process.

After determining each of the one or more individuals appearing in the video scenes 936 and 938, an appearance analyser determines the individuals who appear in more than a predetermined threshold number of the video scenes. Referring to 918, three persons A, B and C are found to have appeared in any of the video scene 936 and/or video scene 938. In the present embodiment, the determination process comprises determining an attribute and a location for each of the one or more individuals who appear in any of the video scenes 936 and 938, where video scene 936 comprises one or more camera surveillance footage of a first location and video scene 938 comprises one or more camera surveillance footage of a second location. Based on the results of the co-appearance search module at 916, Person A is found to have appeared in the video scene 936. Accordingly, as shown in 952, Person A has one appearance in one location. Person B is found to have appeared in the video scene 938. Accordingly, as shown in 954, Person B also has one appearance in one location. Person C, however, is found to have appeared in both video scenes 936 and 938. Accordingly, as shown in 956, Person C has two appearances in two locations.

In the present embodiment, the predetermined threshold number is set as 1. Therefore, if an individual is determined to have appeared in 2 or more video scenes, the individual is then determined to be a potential associate of the target persons. In this case, since Person C is found to have appeared in two video scenes, namely video scene 936 and video scene 938, Person C will be output at 920 as the potential associate of target persons 906 and 908. It will be understood that the predetermined threshold number may be set according to any other number that may produce an optimal result, and may vary according to the number of video scenes being considered.

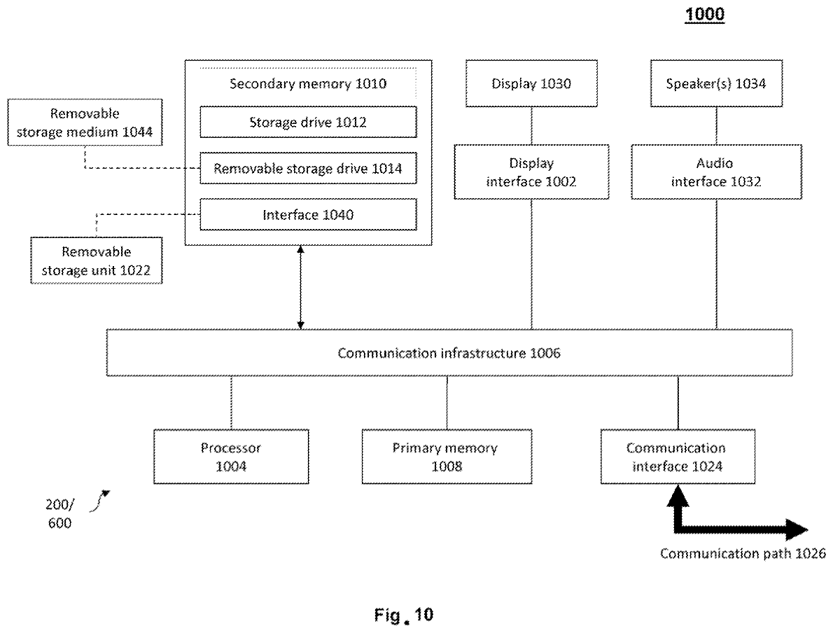

FIG. 10 depicts an exemplary computing device 1000, hereinafter interchangeably referred to as a computer system 1000 or as a device 1000, where one or more such computing devices 1000 may be used to implement the identification device 200 shown in FIG. 2 and/or the identification device 600 shown in FIG. 6. The following description of the computing device 1000 is provided by way of example only and is not intended to be limiting.

As shown in FIG. 10, the example computing device 1000 includes a processor 1004 for executing software routines. Although a single processor is shown for the sake of clarity, the computing device 1000 may also include a multi-processor system. The processor 1004 is connected to a communication infrastructure 1006 for communication with other components of the computing device 1000. The communication infrastructure 1006 may include, for example, a communications bus, cross-bar, or network.

The computing device 1000 further includes a primary memory 1008, such as a random access memory (RAM), and a secondary memory 1010. The secondary memory 1010 may include, for example, a storage drive 1012, which may be a hard disk drive, a solid state drive or a hybrid drive and/or a removable storage drive 1014, which may include a magnetic tape drive, an optical disk drive, a solid state storage drive (such as a USB flash drive, a flash memory device, a solid state drive or a memory card), or the like. The removable storage drive 1014 reads from and/or writes to a removable storage medium 1044 in a well-known manner. The removable storage medium 1044 may include magnetic tape, optical disk, non-volatile memory storage medium, or the like, which is read by and written to by removable storage drive 1014. As will be appreciated by persons skilled in the relevant art(s), the removable storage medium 1044 includes a computer readable storage medium having stored therein computer executable program code instructions and/or data.

In an alternative implementation, the secondary memory 1010 may additionally or alternatively include other similar means for allowing computer programs or other instructions to be loaded into the computing device 1000. Such means can include, for example, a removable storage unit 1022 and an interface 1050. Examples of a removable storage unit 1022 and interface 1050 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1022 and interfaces 1050 which allow software and data to be transferred from the removable storage unit 1022 to the computer system 1000.

The computing device 1000 also includes at least one communication interface 1024. The communication interface 1024 allows software and data to be transferred between computing device 1000 and external devices via a communication path 1026. In various embodiments of the inventions, the communication interface 1024 permits data to be transferred between the computing device 1000 and a data communication network, such as a public data or private data communication network. The communication interface 1024 may be used to exchange data between different computing devices 1000 which such computing devices 1000 form part an interconnected computer network. Examples of a communication interface 1024 can include a modem, a network interface (such as an Ethernet card), a communication port (such as a serial, parallel, printer, GPIB, IEEE 1394, RJ45, USB), an antenna with associated circuitry and the like. The communication interface 1024 may be wired or may be wireless. Software and data transferred via the communication interface 1024 are in the form of signals which can be electronic, electromagnetic, optical or other signals capable of being received by communication interface 1024. These signals are provided to the communication interface via the communication path 1026.

As shown in FIG. 10, the computing device 1000 further includes a display interface 1002 which performs operations for rendering images to an associated display 1030 and an audio interface 1032 for performing operations for playing audio content via associated speaker(s) 1034.

As used herein, the term “computer program product” (or computer readable medium, which may be a non-transitory computer readable medium) may refer, in part, to removable storage medium 1044, removable storage unit 1022, a hard disk installed in storage drive 1012, or a carrier wave carrying software over communication path 1026 (wireless link or cable) to communication interface 1024. Computer readable storage media (or computer readable media) refers to any non-transitory, non-volatile tangible storage medium that provides recorded instructions and/or data to the computing device 1000 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1000. Examples of transitory or non-tangible computer readable transmission media that may also participate in the provision of software, application programs, instructions and/or data to the computing device 1000 include radio or infra-red transmission channels as well as a network connection to another computer or networked device, and the Internet or Intranets including e-mail transmissions and information recorded on Websites and the like.

The computer programs (also called computer program code) are stored in main memory 1008 and/or secondary memory 1010. Computer programs can also be received via the communication interface 1024. Such computer programs, when executed, enable the computing device 1000 to perform one or more features of embodiments discussed herein. In various embodiments, the computer programs, when executed, enable the processor 1004 to perform features of the above-described embodiments. Accordingly, such computer programs represent controllers of the computer system 1000.

Software may be stored in a computer program product and loaded into the computing device 1000 using the removable storage drive 1014, the storage drive 1012, or the interface 1040. The computer program product may be a non-transitory computer readable medium. Alternatively, the computer program product may be downloaded to the computer system 1000 over the communications path 1026. The software, when executed by the processor 1004, causes the computing device 1000 to perform functions of embodiments described herein.

It is to be understood that the embodiment of FIG. 10 is presented merely by way of example. Therefore, in some embodiments one or more features of the computing device 1000 may be omitted. Also, in some embodiments, one or more features of the computing device 1000 may be combined together. Additionally, in some embodiments, one or more features of the computing device 1000 may be split into one or more component parts. The main memory 1008 and/or the secondary memory 1010 may serve(s) as the memory for the device 200; while the processor 1004 may serve as the processor of the identification device 200.

Some portions of the description herein are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the description herein, it will be appreciated that throughout the present specification, discussions utilizing terms such as “receiving”, “providing”, “identifying”, “scanning”, “determining”, “generating”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description herein.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

According to various embodiments, a “module” may be understood as any kind of a logic implementing entity, which may be special purpose circuitry or a processor executing software stored in a memory, firmware, or any combination thereof. Thus, in an embodiment, a “module” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “module” may also be a processor executing software, e.g. any kind of computer program, e.g. a computer program using a virtual machine code such as e.g. Java. Any other kind of implementation of the respective functions which will be described in more detail below may also be understood as a “module” in accordance with an alternative embodiment.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, the whole or part of the exemplary embodiments disclosed above can be described as, but not limited to, the following supplementary notes.

### (Supplementary Note 1)

A method for identifying potential associates of at least one target person, the method comprising:

providing a plurality of videos;

identifying co-appearances with the at least one target person in the plurality of videos;

determining potential associates based on the co-appearances with the at least one target person in the plurality of videos;

identifying co-appearances with the potential associates in the plurality of videos; and

determining further potential associates based on the further co-appearances with the potential associates in the plurality of videos.

### (Supplementary Note 2)

The method according to note 1, further comprising:

determining whether the co-appearances with the potential associates in the plurality of videos include co-appearances that are not included in the co-appearances with the at least one target person in the plurality of videos.

### (Supplementary Note 3)

The method according to note 2,

wherein the further potential associates are determined solely based on the further co-appearances with the potential associates in the plurality of videos, if it is determined that the co-appearances with the potential associates in the plurality of videos include co-appearances that are not included in the co-appearances with the at least one target person in the plurality of videos.

### (Supplementary Note 4)

The method according to note 2,

wherein the further potential associates are determined based on the co-appearances with the at least one target person in the plurality of videos and based on the further co-appearances with the potential associates in the plurality of videos, if it is determined that the co-appearances with the potential associates in the plurality of videos do not include co-appearances that are not included in the co-appearances with the at least one target person in the plurality of videos.

### (Supplementary Note 5)

The method according to note 1, further comprising:

determining whether the further potential associates include individuals that are not included in the potential associates.

### (Supplementary Note 6)

The method according to note 5,

re-iterating processing, if it is determined that the further potential associates include individuals that are not included in the potential associates.

### (Supplementary Note 7)

The method according to note 5,

ending processing, if it is determined that the further potential associates do not include individuals that are not included in the potential associates.

### (Supplementary Note 8)

An identification device configured to identify potential associates of at least one target person, the identification device comprising:

a receiving module configured to receive a plurality of videos;
a co-appearance identification module configured to identify co-appearances with the at least one target person in the plurality of videos;

an associate determination module configured to determine potential associates based on the co-appearances with the at least one target person in the plurality of videos;

wherein the co-appearance identification module is further configured to identify co-appearances with the potential associates in the plurality of videos; and

wherein the associate determination module is further configured to determine further potential associates based on the further co-appearances with the potential associates in the plurality of videos.

### (Supplementary Note 9)

The identification device according to note 8,

wherein the co-appearance identification module is further configured to determine whether the co-appearances with the potential associates in the plurality of videos include co-appearances that are not included in the co-appearances with the at least one target person in the plurality of videos.

### (Supplementary Note 10)

The identification device according to note 9,

wherein the associate determination module is further configured to determine the further potential associates solely based on the further co-appearances with the potential associates in the plurality of videos, if it is determined that the co-appearances with the potential associates in the plurality of videos include co-appearances that are not included in the co-appearances with the at least one target person in the plurality of videos.

### (Supplementary Note 11)

The identification device according to note 9,

wherein the associate determination module is further configured to determine the further potential associates based on the co-appearances with the at least one target person in the plurality of videos and based on the further co-appearances with the potential associates in the plurality of videos, if it is determined that the co-appearances with the potential associates in the plurality of videos do not include co-appearances that are not included in the co-appearances with the at least one target person in the plurality of videos.

### (Supplementary Note 12)

The identification device according to note 8,

wherein the associate determination module is further configured determine whether the further potential associates include individuals that are not included in the potential associates.

### (Supplementary Note 13)

The identification device according to note 12,

wherein the identification device is configured to re-iterate processing, if it is determined that the further potential associates include individuals that are not included in the potential associates.

### (Supplementary Note 14)

The identification device according to note 12,

wherein the identification device is configured to end processing, if it is determined that the further potential associates do not include individuals that are not included in the potential associates.

### (Supplementary Note 15)

A non-transitory computer readable medium having stored thereon instructions which, when executed by a processor, make the processor carry out a method for identifying potential associates of at least one target person, the method comprising:

receiving a plurality of videos;

identifying co-appearances with the at least one target person in the plurality of videos;

determining potential associates based on the co-appearances with the at least one target person in the plurality of videos;

identifying co-appearances with the potential associates in the plurality of videos; and

determining further potential associates based on the further co-appearances with the potential associates in the plurality of videos.

This application is based upon and claims the benefit of priority from Singapore Patent Application No. 10201807663P, filed on Sep. 6, 2018, the disclosure of which is incorporated herein in its entirety by reference.

### REFERENCE SIGNS LIST

202 Receiving Module
204 Appearance Search Module
206 Consolidator Module
418 Target Persons

What is claimed is:

1. A method for identifying potential associates of at least one target person, the method comprising:
providing a plurality of videos;
identifying co-appearances with the at least one target person in the plurality of videos;
determining potential associates based on the co-appearances with the at least one target person in the plurality of videos;
identifying co-appearances with the potential associates in the plurality of videos; and
determining further potential associates based on the further co-appearances with the potential associates in the plurality of videos.

2. The method according to claim 1, further comprising:
determining whether the co-appearances with the potential associates in the plurality of videos include co-appearances that are not included in the co-appearances with the at least one target person in the plurality of videos.

3. The method according to claim 2,
wherein the further potential associates are determined solely based on the further co-appearances with the potential associates in the plurality of videos, if it is determined that the co-appearances with the potential associates in the plurality of videos include co-appearances that are not included in the co-appearances with the at least one target person in the plurality of videos.

4. The method according to claim 2,
wherein the further potential associates are determined based on the co-appearances with the at least one target person in the plurality of videos and based on the further co-appearances with the potential associates in the plurality of videos, if it is determined that the co-appearances with the potential associates in the plurality of videos do not include co-appearances that are not included in the co-appearances with the at least one target person in the plurality of videos.

5. The method according to claim 1, further comprising:
determining whether the further potential associates include individuals that are not included in the potential associates.

6. The method according to claim 5,
re-iterating processing, if it is determined that the further potential associates include individuals that are not included in the potential associates.

7. The method according to claim 5,
ending processing, if it is determined that the further potential associates do not include individuals that are not included in the potential associates.

8. An identification device configured to identify potential associates of at least one target person, the identification device comprising:
a memory in communication with a processor, the memory storing a computer program recorded therein, the computer program being executable by the processor to cause the identification device at least to:
receive a plurality of videos;
identify co-appearances with the at least one target person in the plurality of videos;
determine potential associates based on the co-appearances with the at least one target person in the plurality of videos;
identify co-appearances with the potential associates in the plurality of videos; and
determine further potential associates based on the further co-appearances with the potential associates in the plurality of videos.

9. The identification device according to claim 8, wherein the memory and the computer program is executed by the processor to cause the identification device further to:
determine whether the co-appearances with the potential associates in the plurality of videos include co-appearances that are not included in the co-appearances with the at least one target person in the plurality of videos.

10. The identification device according to claim 9, wherein the memory and the computer program is executed by the processor to cause the identification device further to:
determine the further potential associates solely based on the further co-appearances with the potential associates in the plurality of videos, if it is determined that the co-appearances with the potential associates in the plurality of videos include co-appearances that are not included in the co-appearances with the at least one target person in the plurality of videos.

11. The identification device according to claim 9, wherein the memory and the computer program is executed by the processor to cause the identification device further to:
determine the further potential associates based on the co-appearances with the at least one target person in the plurality of videos and based on the further co-appearances with the potential associates in the plurality of videos, if it is determined that the co-appearances with the potential associates in the plurality of videos do not include co-appearances that are not included in the co-appearances with the at least one target person in the plurality of videos.

12. The identification device according to claim 8, wherein the memory and the computer program is executed by the processor to cause the identification device further to:
determine whether the further potential associates include individuals that are not included in the potential associates.

13. The identification device according to claim 12, wherein the memory and the computer program is executed by the processor to cause the identification device further to:
re-iterate processing, if it is determined that the further potential associates include individuals that are not included in the potential associates.

14. The identification device according to claim 12, wherein the memory and the computer program is executed by the processor to cause the identification device further to:
end processing, if it is determined that the further potential associates do not include individuals that are not included in the potential associates.

15. A non-transitory computer readable medium having stored thereon instructions which, when executed by a processor, make the processor carry out a method for identifying potential associates of at least one target person, the method comprising: receiving a plurality of videos;
identifying co-appearances with the at least one target person in the plurality of videos;
determining potential associates based on the co-appearances with the at least one target person in the plurality of videos;
identifying co-appearances with the potential associates in the plurality of videos; and
determining further potential associates based on the further co-appearances with the potential associates in the plurality of videos.
